(19) United States
(12) Patent Application Publication
(10) Pub. No.: US 2011/0127477 A1
(43) Pub. Date: Jun. 2, 2011

(54) HOIST SYSTEMS

(76) Inventor: MATTHEW PAUL KOKOLIS, OAKDALE, PA (US)

(21) Appl. No.: 12/790,836

(22) Filed: May 30, 2010

Related U.S. Application Data
(60) Provisional application No. 61/217,317, filed on Jun. 1, 2009.
(60) Provisional application No. 61/243,778, filed on Sep. 18, 2009.

(51) Int. Cl. B66D 1/26; B66D 1/36; B66D 1/28

(52) U.S. Cl. 254/285; 254/338; 254/286

(57) ABSTRACT

A hoist system includes a drive system and a shaft in rotatable connection with the drive system. The hoist system also includes a flexible first hoist member operatively connected to the shaft at a first longitudinal position thereon so that it can be wound around the shaft or unwound from around the shaft upon rotation of the shaft. The first hoist member extends from the shaft in a first direction. The hoist system also includes at least a second flexible hoist member operatively connected to the shaft at the first longitudinal position so that it can be wound around the shaft or unwound from around the shaft upon rotation of the shaft. The second hoist member extends from the shaft in a second direction, different from the first direction, so that the first hoist member and the second hoist member are wound around the shaft upon rotation of the shaft in a first or forward direction and are unwound from around the shaft upon rotation of the shaft in a second or reverse direction. The first hoist member and the second hoist member are wound on top of each other when the shaft is rotated in the forward direction. The hoist system also includes a first guide member spaced from the drive shaft on a first side of the drive shaft. The first hoist member passes around at least a portion of the first guide member and extends downward to be operatively connectible to an object to be hoisted. The hoist system further includes a second guide member spaced from the drive shaft on a second side of the drive shaft. The second side is different from the first side. The second hoist member passes around at least a portion of the second guide member and extends downward to be operatively connectible to an object to be hoisted.

### CROSS-REFERENCE TO RELATED APPLICATIONS

This application claims benefit of U.S. Provisional Patent Application Ser. No. 61/217,317 filed Jun. 1, 2009 and U.S. Provisional Patent Application Ser. No. 61/243,778, filed Sep. 18, 2009, the disclosures of which are incorporated herein by reference.

### BACKGROUND

The following information is provided to assist the reader to understand the hoist systems and other devices, systems and/or methods described herein and the environment in which such hoist systems and related devices, systems and/or methods will typically be used. The terms used herein are not intended to be limited to any particular narrow interpretation unless clearly stated otherwise in this document. References set forth herein may facilitate understanding of the hoist systems and other devices, systems and/or methods or the background. The disclosure of all references cited herein are incorporated by reference.

Various types of hoist systems are available for elevating and or lowering objects of various sizes, shapes and weights. However, a number of problems persist with such hoist systems including, but not limited to, difficulty in use with irregularly shaped object, over-complexity in structure and use, and excessive expense. Many commonly available hoists include, for example, a single cable that splits into two or three straps, which can result in uncontrolled rotation or “helicoptering” of the object being hoisted. Such straps can also damage certain objects. Further, many hoist systems with multiple independent straps require multiple motors and motor controllers for operation.

It thus remains desirable to develop hoist systems and/or other devices, systems and/or methods.

### SUMMARY

In one aspect, a hoist system includes a drive system and a shaft in rotatable connection with the drive system. The hoist system also includes a flexible first hoist member operatively connected to the shaft at a first longitudinal position thereon so that it can be wound around the shaft or unwound from around the shaft upon rotation of the shaft. The first hoist member extends from the shaft in a first direction. The hoist system also includes at least a second flexible hoist member operatively connected to the shaft at the first longitudinal position so that it can be wound around the shaft or unwound from around the shaft upon rotation of the shaft. The second hoist member extends from the shaft in a second direction, different from the first direction, so that the first hoist member and the second hoist member are wound around the shaft upon rotation of the shaft in a first or forward direction and are unwound from around the shaft upon rotation of the shaft in a second or reverse direction. The first hoist member and the second hoist member can be wound on top of each other when the shaft is rotated in the forward direction. The hoist system also includes a first guide member spaced from the drive shaft on a first side of the drive shaft. The first hoist member passes around at least a portion of the first guide member and extends downward to be operatively connectible to an object to be hoisted. The hoist system further includes a second guide member spaced from the drive shaft on a second side of the drive shaft. The second side is different from the first side. The second hoist member passes around at least a portion of the second guide member and extends downward to be operatively connectible to an object to be hoisted.

The first direction can, for example, be generally opposite of or opposed to the second direction.

The first hoist member and the second hoist member can, for example, be attached between flanges of a first drum that is attached to the shaft.

In a number of embodiments, the first longitudinal position, the first guide member and the second guide member are positioned to be generally coplanar.

In a number of embodiments, the hoist system further includes a third flexible hoist member and at least a fourth flexible hoist member. The third flexible hoist member is operatively connected to the shaft at a second longitudinal position on the shaft so that it can be wound around the shaft or unwound from around the shaft upon rotation of the shaft. The third hoist member extends from the shaft in the first direction. The second longitudinal position is spaced from the first longitudinal position. The fourth flexible hoist member is operatively connected to the shaft at the second longitudinal position so that it can be wound around the shaft or unwound from around the shaft upon rotation of the shaft. The fourth hoist member extends from the shaft in the second direction, so that the third hoist member and the fourth hoist member are wound around the shaft upon rotation of the shaft in a forward direction and are unwound from around the shaft upon rotation of the shaft in a reverse direction. The third hoist member and the fourth hoist member can be wound on top of each other when the shaft is rotated in the forward direction.

In such embodiments, a third guide member can be spaced from the drive shaft on the first side of the drive shaft. The third hoist member passes around at least a portion of the third guide member and extends downward to be operatively connectible to an object to be hoisted. A fourth guide member can be spaced from the drive shaft on the second side of the drive shaft. The fourth hoist member passes around at least a portion of the fourth guide member and extends downward to be operatively connectible to an object to be hoisted.

Each guide member can, for example, include a rotating member such as a pulley.

The third hoist member and the fourth hoist member can be attached between flanges of a second drum that is attached to the shaft.

The second longitudinal position, the third guide member and the fourth guide member can be positioned to be generally coplanar.

In several embodiments, the first guide member, the second guide member and the first drum are attached to a first extending support member, and the third guide member, the fourth guide member and the second drum are attached to a second extending support member.

The first guide member and the second guide member can, for example, extend generally parallel to each other.

The shaft can extend between the first support member and the second support member, generally perpendicular to the first support member and the second support member.

The first drum can be slidable on the shaft, the second drum can be slidable on the shaft, and the position of the first support member relative to the second support member can be adjustable.

The position of the first guide member on the first support member can be adjustable. The position of the second guide member on the first support member can also adjustable. The position of the third guide member on the second support member can be adjustable. The position of the fourth guide member on the second support member can also be adjustable.

The distance between the first longitudinal position and the second longitudinal position can be adjustable.

A first connector can be attached to the first hoist member; a second connector can be attached to the second hoist member; a third connector can be attached to the third hoist member; and a fourth connector can be attached to the fourth hoist member.

The height of the first, second, third and/or fourth connector can be adjustable.

In another aspect, a hoist system for raising or lowering an object includes four flexible extending hoist members and a frame system. Each of the hoist members extends downward from the frame system in a pattern. Each hoist member includes a connector to connect to the object to be raised or lowered. Each of the hoist members is in operative connection with a single drive system operable to raise or lower the ends of the hoist members. The pattern is adjustable in shape.

In another aspect, a hoist system for raising or lowering an object includes four flexible extending hoist members and a frame system. Each of the hoist members extends downward from the frame system in a pattern. Each hoist member includes a connector to connect to the object to be raised or lowered. Each of the hoist members is in operative connection with a single drive system operable to raise or lower the ends of the hoist members. The pattern can be adjustable in shape. The vertical position of each connector can be adjustable independent of the other connectors.

In a further aspect, a hoist system includes a drive system and a shaft in rotatable connection with the drive system. A flexible first hoist member is operatively connected to the shaft at a first longitudinal position thereon so that it can be wound around the shaft or unwound from around the shaft upon rotation of the shaft. The first hoist member extends from the shaft in a first direction. The hoist system also includes at least a second flexible hoist member operatively connected to the shaft at the first longitudinal position so that it can be wound around the shaft or unwound from around the shaft upon rotation of the shaft. The second hoist member extends from the shaft in a second direction, different from the first direction, so that the first hoist member and the second hoist member are wound around the shaft upon rotation of the shaft in a forward direction and are unwound from around the shaft upon rotation of the shaft in a reverse direction. The hoist system further includes a first guide member spaced from the drive shaft on a first side of the drive shaft. The first hoist member passes around at least a portion of the first guide member and extends downward to be operatively connectible to an object to be hoisted. The hoist system also includes a second guide member spaced from the drive shaft on a second side of the drive shaft. The second side is different from the first side. The second hoist member passes around at least a portion of the second guide member and extends downward to be operatively connectible to an object to be hoisted. A distance between the first guide member and the second guide member is adjustable.

In still a further aspect, a system to move an object includes a drive system, a shaft in rotatable connection with the drive system, and a flexible first member operatively connected to the shaft at a first longitudinal position thereon so that it can be wound around the shaft or unwound from around the shaft upon rotation of the shaft. The first member extends from the shaft in a first direction to attach to the object at a first position thereon. The system further includes at least a second flexible member operatively connected to the shaft at a second longitudinal position so that it can be wound around the shaft or unwound from around the shaft upon rotation of the shaft. The second member extends from the shaft in a second direction, different from the first direction, to attach to the object at a second position that is spaced from the first position, so that the first member is unwound from the shaft upon rotation of the shaft in a first rotational direction and the second member is wound around the shaft upon rotation of the shaft in the first rotational direction.

The hoist systems and/or other devices, systems and/or methods, along with the attributes and attendant advantages thereof, will best be appreciated and understood in view of the following detailed description taken in conjunction with the accompanying drawings.

### BRIEF DESCRIPTION OF THE DRAWINGS

FIG. 1 illustrates a perspective view of an embodiment of a hoist system.

FIG. 2A illustrates an enlarged side view of an embodiment of a drum to which two, generally opposing hoisting members are attached, wherein a guide flange of the drum is illustrated as transparent.

FIG. 2B illustrates an enlarged side view of the drum of FIG. 2A wherein the hoisting members are being wound around the drum.

FIG. 3 illustrates another perspective view of the hoist system of FIG. 1.

FIG. 4 illustrates an embodiment of a hoist system in the process of elevating a hard top of a car.

FIG. 5A illustrates an embodiment of a system for translating the position of an object (for example, for raising and lowering a door).

FIG. 5B illustrates an enlarged view of the connection of two hoisting members to the drive shaft of the system of FIG. 5A.

### DETAILED DESCRIPTION

As used herein and in the appended claims, the singular forms “a,” “an”, and “the” include plural references unless the content clearly dictates otherwise. Thus, for example, reference to “a connector” includes a plurality of such connectors and equivalents thereof known to those skilled in the art, and so forth, and reference to “the connector” is a reference to one or more such connectors and equivalents thereof known to those skilled in the art, and so forth.

In several embodiments, the hoist systems of the present invention provide multiple points of attachment for an object to be hoisted. The hoist system can, for example, be installed overhead (for example, attached to a ceiling), and objects can be raised and lowered using multiple flexible hoist members such as straps, ropes, cables, chains and/or similar members. In several embodiments, the hoist system includes a single drive system (for example, a motor, a manual drive system, a hydraulic drive system etc.) that can, for example, be controlled via manual switches or wirelessly (for example, using a RF receiver/RF transmitter combination) to raise or lower the hoist members and thereby the object attached to the hoist members. The hoist system can be used to raise and lower objects of regular and/or irregular size and/or shape

In the case of a two-point system, two hoisting members (the ends of each which can include a connector to attach to an attachment point on the object) are operatively connected to the single drive system so that each of the hoisting members can be raised/lowered by control of the drive system, thereby raising or lowering the attached object. In the case of a four-point system, four hoisting members are attached to four points on an object to be raised/lowered. The four hoisting members are operatively connected to the single drive system so that each of the hoisting member can be raised/lowered by control of the drive system, thereby raising or lowering the attached object. A four-point hoist system is particular advantageous as the four points of connection to the object provide stability in raising and lowering the object. More than four points of attachment are readily provided in the hoist systems and other systems of the present invention to cooperate with objects of generally any sized and/or shape.

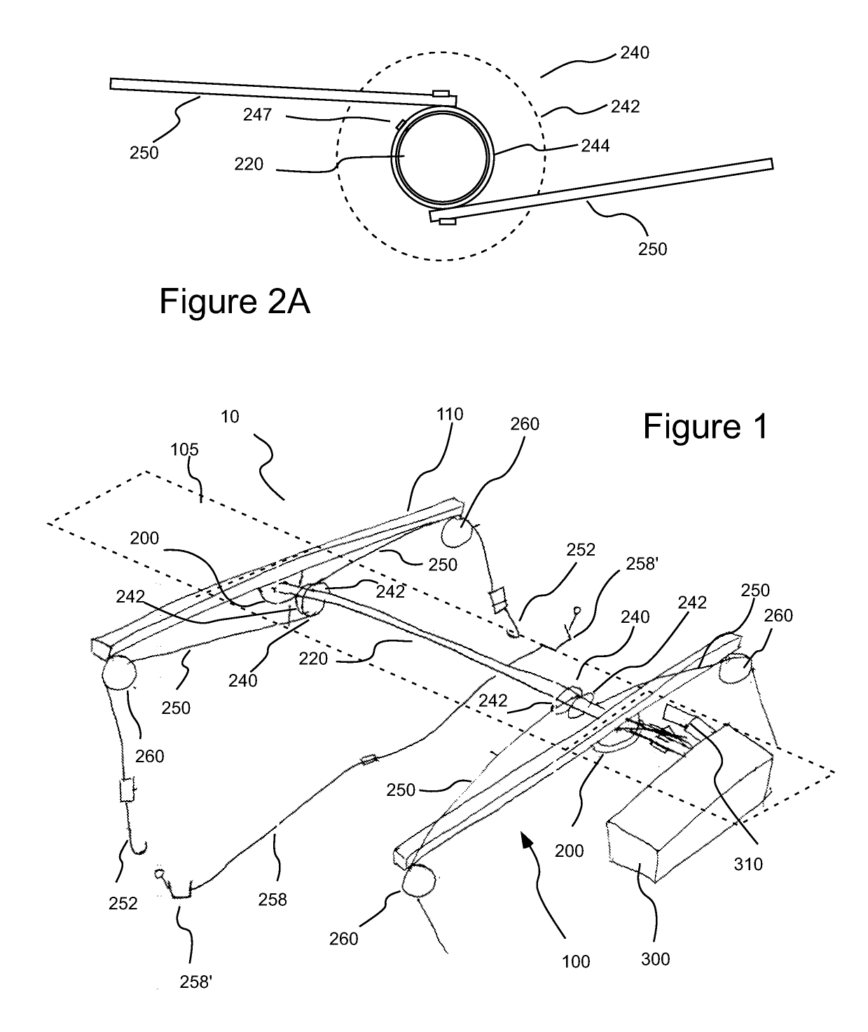

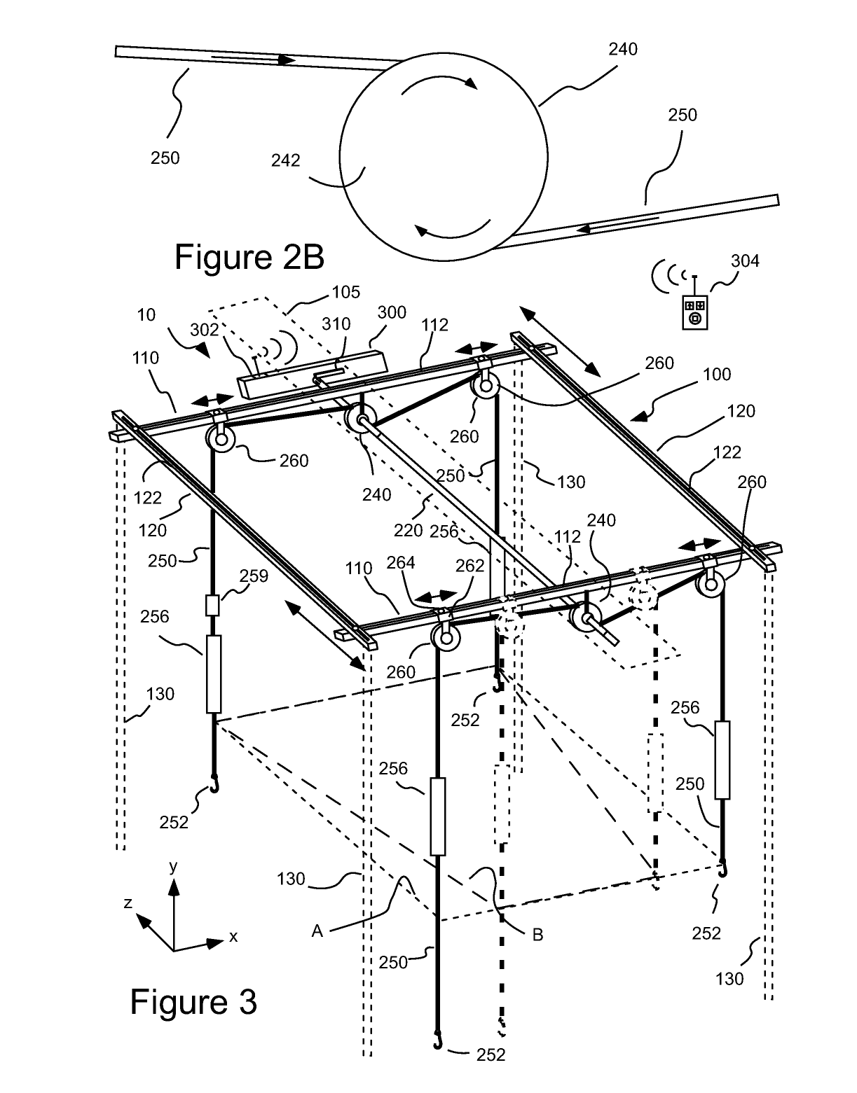

An embodiment of a four-point hoist system 10 is illustrated in FIGS. 1 through 4. In the illustrated embodiment, hoist system 10 includes a frame or support system 100 including two (2) extending support members or support bars 110, formed, for example, from square tubing or stock. Support members 110 can, for example, be mounted to a stable, elevated structure (for example, ceiling joist, a suspended framework, I-Beams, etc.). In the embodiment illustrated in FIG. 1, pillow block bearings 200 are attached to support members 110, generally at the center of support members 110. Pillow block bearings 100 accept a drive shaft 220 of hoist system 10, which is generally freely rotatable within pillow block bearings 200. In a number of embodiments, an attachment bracket or frame bracket 105 (illustrated schematically in dashed lines in FIGS. 1 and 2B) can first be attached to the stable, elevated structure and, for example, support members 110 and pillow block bearings 200 can be attached thereto. Frame bracket 105 can, for example, include an attachment system as know in the attachment arts to ensure proper alignment and/or positioning of support members 100 and pillow block bearings 200 at one or more positions.

In the illustrated embodiments, drive shaft 220 is a metal tube or cylinder of generally circular cross-section that extends generally perpendicularly from pillow block bearing 200 of one support member 110 to pillow block bearing 200 of another support member 110. In the vicinity of each support bar 110, drive shaft 220 includes a drum or spool 240, which is formed by two spaced flanges 242 (of generally circular shape) attached to drive shaft 220 and positioned inside of pillow block bearings 200. Flanges 242 receive a flexible, extending hoist member 250 (for example, a strap, a ropes, a cable, a chains and/or a similar member) from each side of drive shaft 220 therebetween, and aid in the winding up process by guiding the winding of hoist members 250. Flanges 242 can be attached directly to drive shaft 220 or can be attached to a generally cylindrical member 244 through which drive shaft 220 passes (see FIG. 2A). Flanges 242 and cylindrical member 244 (or drive shaft 220) form drum 240 about which hoisting members 250 are windable or coilable. As illustrated in FIG. 2A, hoist member 250 extending to the right side of drive shaft 220 (in, for example, the orientation of FIG. 2A and 2B) is mounted on the bottom of cylindrical member 244, while hoisting member 250 extending to the left side of drive shaft 220 is mounted at the top of drive shaft 220 (for example, using a connector such as a rivet).

Guide members 260, which can include rotating members such as pulleys (for example, flat-belt pulleys), are mounted at spaced positions on each support member 110 and can rotate with movement of hoist members 250. Guide members 260 receive, position and guide flexible hoist members 250, which are operatively connected to drive shaft 220 as described above to raise and lower the object as described above. The relative positions of guide members 260 on support members 110, the spacing between support members 110 and the spacing between drums 240 can be adjustable to adjust the position and/or pattern hoist members 250 and attachment points or connectors 252 on the distal ends of hoist members 250.

FIG. 3 illustrates an example of a manner in which the position and/or pattern of hoist members 250 can be adjusted or changed to facilitate the hoisting of a particular object. In the illustrated embodiment, the guide members 260 are slidable along support members 110 to change the relative position or spacing of guide members 260 along support members 110. A change in position of two of guide members 240 is show in dashed lines. The change in position results in a change of the pattern of hoist members 250 (in general, a projection of the positions of hoist members 250 into a generally horizontal plane) from a generally rectangular pattern A to a generally trapezoidal pattern B. Each of horizontal members 110 can, for example, include a continuous slot 112 therethrough along which attachment members 262 (via which guide members 260 are attached to support members 110) are slidable (in the direction of axis x) to be secured (for example, via a connector 264). The distance or spacing between support members 110 (in the direction of axis z) can, for example, be adjusted by sliding one or both support members 110 along generally perpendicular support members 120 of support or frame system 100. Support members 120 can, for example, include slots 122 or other continuous or discontinuous positioning elements to provide for such adjustment. Support members 110 can be parallel to each other, while support members 120 can be perpendicular to support members 110 and parallel to each other.

Two guide members 260 as well as cooperating drum 240 can all be connected to one support member 110 (see, for example, FIG. 3) to maintain a desired alignment thereof as well as to enable adjustment of the position thereof in the z axis at the same time that the position of support member 110 is adjusted, while maintaining the desired alignment thereof. Drum 240 can, for example, be placed in controllable locking connection with drive shaft 220 via one or more locking connector 247 (see FIG. 2A). Many locking connectors as known in the art can be used in connection with the position adjustment of the drums, guide members and support members. Such locking connectors can be readily accessible and adjustable to facilitate set-up.

Guide members 260 and drum 240 associated with a particular support member 110 can, for example, be positioned to be generally coplanar or close to coplanar so that hoist members 250 extend in generally the same plane. Such positioning can, for example, assist in ensuring that hoist members remain in engagement with guide members 260 and can reduce wear upon hoist members 250.

Support members 120 can, for example, be placed in attachment with an overhead ceiling or other overhead anchorage system (either directly of via frame bracket 105). Alternatively, support system 100 can be provided with extending members or legs 130 (shown in dashed lines in FIG. 3) to provide support for support members 120, and thereby for support members 110.

When hoist system 10 is in the process of hoisting or lifting, hoist members 250 wind around cylindrical member 244 (and thus around drive shaft 220), between the guide flanges 242, and on top of each other. As this action occurs, the circumference of the wound hoist members 250 becomes larger and, thus, the speed at which hoist system 10 lifts the attached object increases (assuming drive shaft 220 is rotated at a constant angular velocity). In many circumstances, it is desirable to begin raising an object relatively slowly and then increase the speed of lifting. The speed rotation of drive shaft 220 can be controlled (including varied) to control the rate of raising/lowering of the object.

A motor 300 is attached to the rear of the drive shaft 220, and can rotate drive shaft 220 in either direction. Motor 300 can, for example, be geared to lift objects at an initial rate of approximately 5 inches per second. Motor 300 can, for example, be powered via a standard household electrical outlet (115 volts), and can, for example, be controlled with a receiver or transceiver 302 (see FIG. 3) and a corresponding RF transmitter or transceiver 302 (see FIG. 3) as described above. In a number of embodiments, motor 300 houses a solenoid that operates a breaking system 310 (for example, a ratchet and pawl braking system). Braking system 310 can, for example, operate as an emergency break system in the event of power failure.

However, because a first hoist member 250 is operatively connected to the shaft 220 (via drum 240 in the illustrated embodiments) so that it extends from shaft 220 in a first direction, and a second hoist member 250 is operatively connected to the shaft 220 (via drum 240 in the illustrated embodiments) so that it extends from shaft 220 in a second direction, different from or opposing the first direction, the counteracting forces upon the first and second hoist members 250 tend to prevent rotation of shaft 220 (and corresponding movement of any attached load), even upon failure of motor 300 or other system element(s), thereby provide an inherent mechanism preventing downward movement of an attached load.

At least one of hoisting members 250 can, for example, be provided with a limiter member or switch 259 (see FIG. 3) to communicate with motor 300 to limit the length of hoisting member 250 that can be wound around drum 240, thereby limiting the height to which an object can be raised. Limiter switch 259 can, for example, be actuated by contact with guide member 260.

Weight members 256 can be connected in line with hoist members 250 to assist in accurately positioning and maintaining a desired position/pattern of hoist members 250. The length or position/height of the distal ends of the hoist members (opposite the end attached to drum 240/drive shaft 220) and position/height of connectors 250 attached thereto can, for example, be adjustable. Such adjustability can, for example, enable the user to readily adjust hoist members 250 to connect to and control the position/height of objects of irregular shape. Connector 252 (for example, a hook in the illustrated embodiments) can be used to attach (either directly or indirectly) to the object to be hoisted. Connectors 252 can, for example, attach indirectly to an object via an abutment or receiving member 258 (see FIG. 1) which attaches to one, two or more of connectors 252 and is placed in abutting or receiving contact with the object. Abutment or receiving member 258 can be flexible or rigid, and can include receivers 258′ dimensioned to cooperate with or seat portions of a certain object to be hoisted.

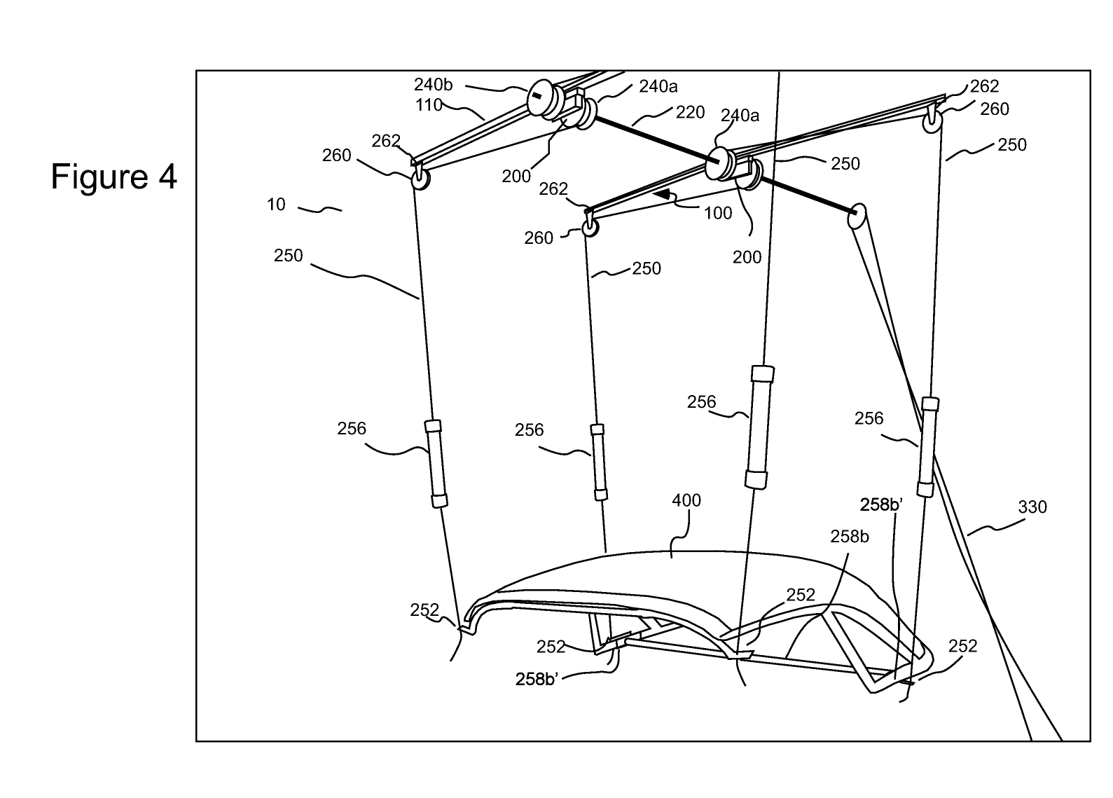

FIG. 4 illustrates hoist system 10 in operation to lift a car hard top 400. In FIG. 4, rear connectors 252 are illustrated to be lower than front connectors 252 to connect to the irregularly shaped hard top 400. Rear connectors 252 are attached to a rigid abutment or receiving member 258b that extends under a rearward section of hard top 400.

In FIG. 4, two drums 240a and 240b are provided on each side of drive shaft 220. One hoist member 250 is connected to each of drums 240a and 240b.

Drive shaft 220 is connected to a drive system (for example, motor 300 or other drive system) via a chain 330.

The hoist members of the hoist systems can, for example, be used to facilitate installation of the hoist system. In such a procedure, one can attach the hoist member connectors (for example, hooked ends) to a desired stable elevated structure or anchorage (for example, ceiling joist, suspended frame work, I-Beams, etc.), and activate the hoist system. The hoist system will literally lift itself into the elevated area. From this point, the hoist system can be fastened securely to the stable elevated structure(s)/fixture(s).

As described, for example, in connection with FIGS. 1 through 4, hoist systems described herein can be used in connection with many objects of nearly limitless shape and/or size. For example, the hoist systems can be in connection with many automobile components such as hard tops, truck cabs, chassis etc. Two connection points can, for example, be used in raising one portion of a vehicle (for example, a front or rear end) or other object. Further, additional support members and associated drums and guide members are readily incorporated to cooperate with larger objects.

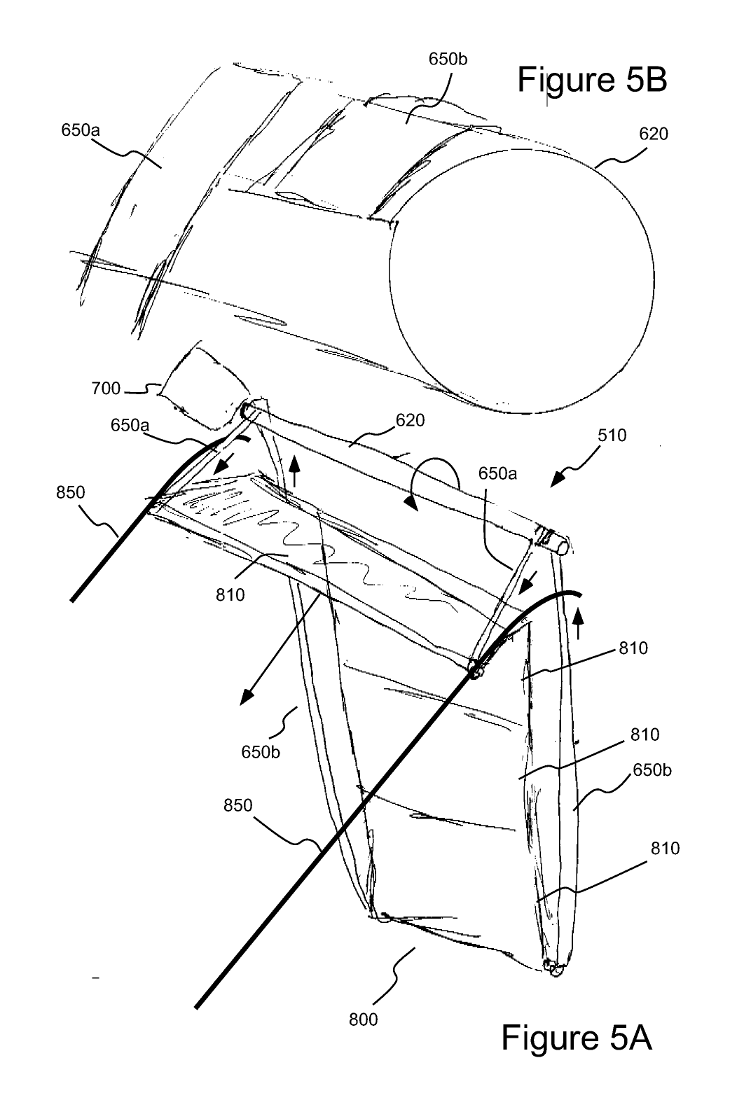

FIGS. 5A and 5B illustrate another system 510 that can be used to move or translate (for example, in a reciprocating manner) an object from one position to another (for example, along a guide or track system). In the illustrated embodiment, hoist system 510 includes a drive shaft 620 to which hoist members 650a and hoist members 650b are attached. Each of hoist members 650a is attached at a first position (for example, at one end—a top end in FIG. 5A) of a garage-type door 800 (which includes a plurality of hinged sections or panels 810) at a side of door 800. Each of hoist members 650b is attached at a second position (for example, at another end—a bottom end in FIG. 5A) of door 800 at a side of door 800.

As illustrated in, for example, FIG. 5B, hoist members 650a and 650b are attached to drive shaft 620 at spaced positions thereon such that, upon rotation of the drive shaft 620, hoist members 650a and 650b are wound or coiled about drive shaft 620 in the same direction. In general, each of hoist members 650a and hoist members 650b are the same length. When door 800 is in a down or closed position, hoist members 650a are almost completely wound upon drive shaft 620, while hoist members 650b are almost completely unwound from drive shaft 620. As, for example, illustrated in FIG. 5A, during raising or opening of door 800, drive shaft 620 is rotated in a counterclockwise direction (via motor 700), hoist members 650a are unwound from or extended from drive shaft 620, and hoist members 650b are wound upon drive shaft 620. Door 800 is raised as a result of the force applied by hoisting members 650b to the bottom end of door 800, following track system 850 as known in the art. To lower door 800, drive shaft 620 is rotates in a clockwise direction so that hoist members 650a are wound upon drive shaft 620 and hoist members 650b are unwound from drive shaft 620. The force applied to the top end of door 800 by hoist members 650a results in movement of door 800 along track system 850 to a closed position (or to any position between an open position and a closed position).

Although four hoist members are illustrated in connection with FIGS. 5A and 5B, it is possible to move or translate the position of door 800 and other objects using only two hoist members (such as hoist members 650a and hoist member 650b).

The foregoing description and accompanying drawings set forth embodiments of the hoist systems and related devices, systems and methods at the present time. Various modifications, additions and alternative designs will, of course, become apparent to those skilled in the art in light of the foregoing teachings without departing from the scope hereof, which is indicated by the following claims rather than by the foregoing description. All changes and variations that fall within the meaning and range of equivalency of the claims are to be embraced within their scope.

What is claimed is:

1. A hoist system comprising:
a drive system,
a shaft in rotatable connection with the drive system,
a flexible first hoist member operatively connected to the shaft at a first longitudinal position thereon so that it can be wound around the shaft or unwound from around the shaft upon rotation of the shaft, the first hoist member extending from the shaft in a first direction;
at least a second flexible hoist member operatively connected to the shaft at the first longitudinal position so that it can be wound around the shaft or unwound from around the shaft upon rotation of the shaft, the second hoist member extending from the shaft in a second direction, different from the first direction, so that the first hoist member and the second hoist member are wound around the shaft upon rotation of the shaft in a forward direction and are unwound from around the shaft upon rotation of the shaft in a reverse direction; the first hoist member and the second hoist member being wound on top of each other when the shaft is rotated in the forward direction;
a first guide member spaced from the drive shaft on a first side of the drive shaft, the first hoist member passing around at least a portion of the first guide member and extending downward to be operatively connectible to an object to be hoisted; and
a second guide member spaced from the drive shaft on a second side of the drive shaft, the second side being different from the first side, the second hoist member passing around at least a portion of the second guide member and extending downward to be operatively connectible to an object to be hoisted.

2. The hoist system of claim 1 wherein the first direction is generally opposite of the second direction.

3. The hoist system of claim 2 wherein the first hoist member and the second hoist member are attached between flanges of a first drum that is attached to the shaft.

4. The hoist system of claim 3 wherein the first longitudinal position, the first guide member and the second guide member are positioned to be generally coplanar.

5. The hoist system of claim 1 further comprising:
a third flexible hoist member operatively connected to the shaft at a second longitudinal position on the shaft so that it can be wound around the shaft or unwound from around the shaft upon rotation of the shaft, the third hoist member extending from the shaft in the first direction, the second longitudinal position being spaced from the first longitudinal position;
at least a fourth flexible hoist member operatively connected to the shaft at the second longitudinal position so that it can be wound around the shaft or unwound from around the shaft upon rotation of the shaft, the fourth hoist member extending from the shaft in the second direction, so that the third hoist member and the fourth hoist member are wound around the shaft upon rotation of the shaft in a forward direction and are unwound from around the shaft upon rotation of the shaft in a reverse direction; the third hoist member and the fourth hoist member being wound on top of each other when the shaft is rotated in the forward direction;
a third guide member spaced from the drive shaft on the first side of the drive shaft, the third hoist member passing around at least a portion of the third guide member and extending downward to be operatively connectible to an object to be hoisted; and
a fourth guide member spaced from the drive shaft on the second side of the drive shaft, the fourth hoist member passing around at least a portion of the fourth guide member and extending downward to be operatively connectible to an object to be hoisted.

6. The hoist system of claim 3 further comprising:
a third flexible hoist member operatively connected to the shaft at a second longitudinal position on the shaft so that it can be wound around the shaft or unwound from around the shaft upon rotation of the shaft, the third hoist member extending from the shaft in the first direction;
at least a fourth flexible hoist member operatively connected to the shaft at the second longitudinal position so that it can be wound around the shaft or unwound from around the shaft upon rotation of the shaft, the fourth hoist member extending from the shaft in the second direction, so that the third hoist member and the fourth hoist member are wound around the shaft upon rotation of the shaft in a forward direction and are unwound from around the shaft upon rotation of the shaft in a reverse direction; the third hoist member and the fourth hoist member being wound on top of each other when the shaft is rotated in the forward direction, the second longitudinal position being spaced from the first longitudinal position;
a third guide member spaced from the drive shaft on the first side of the drive shaft, the third hoist member passing around at least a portion of the third guide member and extending downward to be operatively connectible to an object to be hoisted; and
a fourth guide member spaced from the drive shaft on the second side of the drive shaft, the fourth hoist member passing around at least a portion of the fourth guide member and extending downward to be operatively connectible to an object to be hoisted.

7. The hoist system of claim 6 wherein the third hoist member and the fourth hoist member are attached between flanges of a second drum that is attached to the shaft.

8. The hoist system of claim 7 wherein the second longitudinal position, the third guide member and the fourth guide member are positioned to be generally coplanar.

9. The hoist system of claim 7 wherein the first guide member, the second guide member and the first drum are attached to a first extending support member, and the third guide member, the fourth guide member and the second drum are attached to a second extending support member.

10. The hoist system of claim 9 wherein the first guide member and the second guide member extend generally parallel to each other.

11. The hoist system of claim 10 wherein the shaft extends between the first support member and the second support member, generally perpendicular to the first support member and the second support member.

12. The hoist system of claim 11 wherein the first drum is slidable on the shaft, the second drum is slidable on the shaft, and the position of the first support member relative to the second support member is adjustable.

13. The hoist system of claim 11 wherein a position of the first guide member on the first support member is adjustable, a position of the second guide member on the first support member is adjustable, a position of the third guide member on the second support member is adjustable, and a position of the fourth guide member on the second support member is adjustable.

14. The hoist system of claim 6 wherein a distance between the first longitudinal position and the second longitudinal position is adjustable, a position of the first guide member is adjustable, a position of the second guide member is adjustable, a position of the third guide member is adjustable and a position of the fourth guide member is adjustable.

15. The hoist system of claim 6 further comprising a first connector attached to the first hoist member, a second connector attached to the second hoist member, a third connector attached to the third hoist member and a fourth connector attached to the fourth hoist member.

16. The hoist system of claim 15 wherein a height of the first connector is adjustable, a height of the second connector is adjustable, a height of the third connector is adjustable and a height of the fourth connector is adjustable.

17. A hoist system for raising or lowering an object, comprising: four flexible extending hoist members and a frame system, each of the hoist members extending downward from the frame system in a pattern, each hoist member including a connector to connect to the object to be raised or lowered, each of the hoist members being in operative connection with a single drive system operable to raise or lower the ends of the hoist members, the pattern being adjustable in shape.

18. A hoist system comprising:
a drive system,
a shaft in rotatable connection with the drive system,
a flexible first hoist member operatively connected to the shaft at a first longitudinal position thereon so that it can be wound around the shaft or unwound from around the shaft upon rotation of the shaft, the first hoist member extending from the shaft in a first direction;
at least a second flexible hoist member operatively connected to the shaft at the first longitudinal position so that it can be wound around the shaft or unwound from around the shaft upon rotation of the shaft, the second hoist member extending from the shaft in a second direction, different from the first direction, so that the first hoist member and the second hoist member are wound around the shaft upon rotation of the shaft in a forward direction and are unwound from around the shaft upon rotation of the shaft in a reverse direction;
a first guide member spaced from the drive shaft on a first side of the drive shaft, the first hoist member passing around at least a portion of the first guide member and extending downward to be operatively connectible to an object to be hoisted; and
a second guide member spaced from the drive shaft on a second side of the drive shaft, the second side being different from the first side, the second hoist member passing around at least a portion of the second guide member and extending downward to be operatively connectible to an object to be hoisted, a distance between the first guide member and the second guide member being adjustable.
